(19) United States
(12) Patent Application Publication
(10) Pub. No.: US 2023/0049496 A1
(43) Pub. Date: Feb. 16, 2023

(54) MACHINE LEARNING FOR RF IMPAIRMENT DETECTION

(71) Applicant: ARRIS Enterprises LLC, Suwanee, GA (US)

(72) Inventors: David Emery VIRAG, Johns Creek, GA (US); Santhana CHARI, Johns Creek, GA (US); Stephen J. KRAIMAN, Doylestown, PA (US)

(73) Assignee: ARRIS Enterprises LLC, Suwanee, GA (US)

(21) Appl. No.: 17/881,451

(22) Filed: Aug. 4, 2022

Related U.S. Application Data
(60) Provisional application No. 63/229,396, filed on Aug. 4, 2021.
(60) Provisional application No. 63/230,467, filed on Aug. 6, 2021.
(60) Provisional application No. 63/394,800, filed on Aug. 3, 2022.

(51) Int. Cl. H04B 17/318; H04B 17/391; H04H 20/78

(52) U.S. Cl. CPC H04B 17/318; H04B 17/391; H04H 20/78

(57) ABSTRACT

Systems and methods for automatically analyzing spectral power measurements to identify abnormalities. The systems and methods may receive measurements comprising RF power measured over a contiguous range of frequencies, where at least a first portion of the contiguous range is used to transmit signals and at least a second portion of the contiguous range is unused. Respective boundaries of the unused portions may be identified and infilled to provide modified measurements. The modified measurements may be automatically analyzed to identify the abnormalities.

### CROSS REFERENCE TO RELATED APPLICATIONS

The present application claims priority under 35 U.S.C. § 119(e) from earlier filed U.S. Provisional Application Ser. No. 63/229,396, filed Aug. 4, 2021, U.S. Provisional Application Ser. No. 63/230,467, filed Aug. 6, 2021, and U.S. Provisional Application Ser. No. 63/394,800, filed Aug. 3, 2022, the contents of which are each incorporated herein by reference in their entirety.

### BACKGROUND

The subject matter of this application generally relates to systems and methods that aggregate network maintenance data in communications networks, such as Hybrid Fiber Coax (HFC) systems.

Cable Television (CATV) services have historically provided content to large groups of subscribers from a central delivery unit, called a “head end,” which distributes channels of content to its subscribers from this central unit through a branch network comprising a multitude of intermediate nodes. Modern CATV service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber, and to the content provider through the branch network.

To this end, these CATV head ends include a separate Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many modern CATV systems have combined the functionality of the CMTS with the video delivery system (EdgeQAM) in a single platform called the Converged Cable Access Platform (CCAP). Still other modern CATV systems called Remote PHY (or R-PHY) relocate the physical layer (PHY) of a traditional CCAP by pushing it to the network's fiber nodes. Thus, while the core in the CCAP performs the higher layer processing, the R-PHY device in the node converts the downstream data sent by the core from digital-to-analog to be transmitted on radio frequency and converts the upstream RF data sent by cable modems from analog-to-digital format to be transmitted optically to the core. Other modern systems push other elements and functions traditionally located in a head end into the network, such as MAC layer functionality (R-MACPHY), etc.

CATV systems traditionally bifurcated available bandwidth into upstream and downstream transmissions, i.e., data is only transmitted in one direction across any part of the spectrum. For example, early iterations of the Data Over Cable Service Interface Specification (DOCSIS) assigned upstream transmissions to a frequency spectrum between 5 MHz and 42 MHz and assigned downstream transmissions to a frequency spectrum between 50 MHz and 750 MHz. Later iterations of the DOCSIS standard expanded the width of the spectrum reserved for each of the upstream and downstream transmission paths, but the spectrum assigned to each respective direction did not overlap. Recently however, proposals have emerged by which portions of spectrum may be shared by upstream and downstream transmission, e.g., full duplex and soft duplex architectures.

Regardless of which of the foregoing architectures are employed, over the past decade, CableLabs DOCSIS standards have introduced a variety of PNM (Proactive Network Measurement) tests for the collection of operational data from various network elements such as the CMs (Cable Modems) and the CMTSs. Proactive Network Maintenance (PNM) measurements are used in cable access networks to collect data that provides information about the status of the network, from which network configuration, maintenance, or other corrective actions may be taken. PNM measurements, for example, include full-band spectrum (FBS) capture data that measures signal quality in both upstream and downstream directions across the full network spectrum. Such measurement may be used, for example, to arrange or rearrange cable modems into interference groups in full duplex architectures, adjust modulation profiles in specific subcarriers, etc. Other PNM measurements may measure signal quality in only specific subcarriers, and in either case signal quality may be measured using any of a number of metrics, e.g., Signal-to-Noise (SNR) Modulation Error Ratio (MER), impulse noise measurements etc. Other PNM measurements may measure distortion products from which pre-equalization coefficients may be derived, which are used to pre-distort transmitted signals to compensate for optical distortion that occurs in the fiber portion of the network. Other PNM measurements may include impulse noise measurements, histograms, and any other metric relevant to a state of the transmission network. These PNM measurements are often performed independently for the upstream (US) and downstream (DS) channels by collecting the relevant data from the CMTS and Cable Modems (CM) respectively.

The operational data available in the network can be extremely large when taken at time intervals sufficient to allow pro-active as opposed to re-active network management. Historically, these sort of data available in the cable network require one skilled in the domain of radio frequency engineering to interpret the spectral data available from the system to identify abnormalities or defects in the RF spectrum. Typical RF impairments that occur in the cable coaxial networks are suck-out, tilt, roll-off, etc. FBS capture data, which measures received RF power over the full RF spectrum, is typically used to identify the presence of the aforementioned RF impairments.

Discerning the quality of an RF spectral signal visually is time consuming and fraught with nuance such that human review of this data is done in a reactive manner where issues are already known as opposed to a proactive manner to determine where issues are arising that may not yet be having major impacts on network performance and quality of service.

What is desired, therefore, are improved systems and methods to identify defects or abnormalities in RF spectrum in a communications network.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary HFC network from a head end to a node that serves a plurality of home subscribers.

FIGS. 2A and 2B show exemplary abnormalities in RF spectrum due to suck-out and roll-off, respectively.

FIGS. 3A and 3B each illustrate examples of a captured downstream RF spectrum having areas where spectrum is unused.

FIG. 4 shows an exemplary method in accordance with an embodiment disclosed in the present application.

FIG. 5 shows the benefits of the method of FIG. 4.

FIG. 6 shows an exemplary machine learning pipeline for implementing some embodiments of the present disclosure.

FIG. 7 shows a typical radio frequency (RF) Full Band Spectrum (FBS) capture.

FIG. 8 shows the FBS capture of FIG. 7 with a −60 dBmV infill.

FIG. 9 shows exemplary learning curves used in evaluating a variety of machine learning algorithms.

FIGS. 10 and 10 B show results of several machine learning algorithms according to embodiments disclosed herein where test accuracy was PCA=90.

FIGS. 11A and 11B show results of several machine learning algorithms according to embodiments disclosed herein where test accuracy was PCA=99.

FIG. 12 shows an exemplary system implementing the machine learning techniques described in this application.

FIG. 13 shows a confusion matrix.

### DETAILED DESCRIPTION

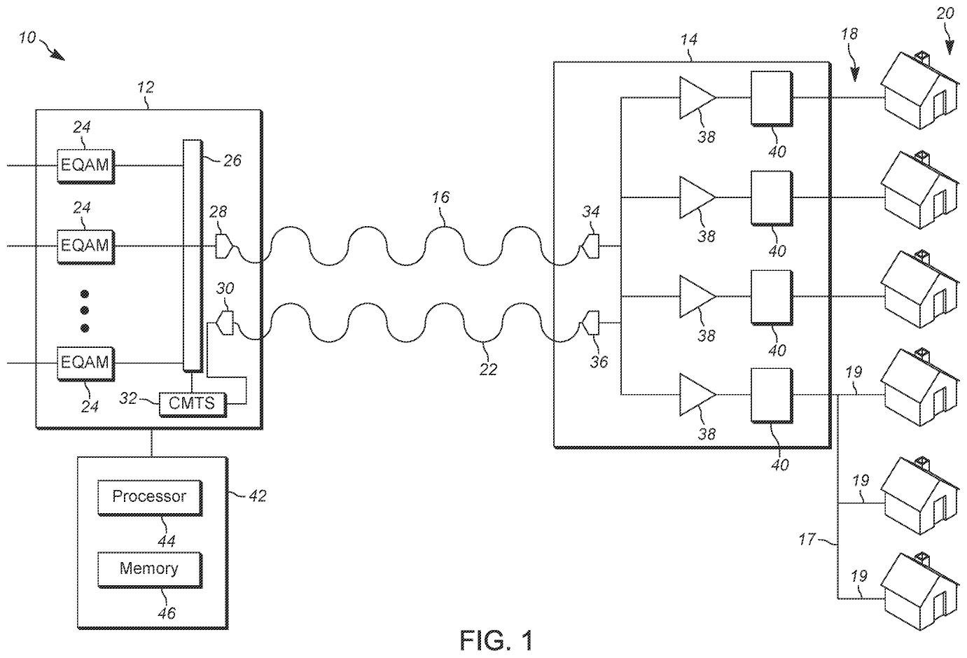

The systems and methods disclosed in the present application will be described in relation to an exemplary Hybrid Fiber-Coaxial (HFC) network that is used for illustrative purposes only, as the systems and methods described in the present specification may also apply to any other information-carrying network, such as telephone networks, optical communications networks, etc. Specifically referring to FIG. 1, an exemplary Hybrid Fiber-Coaxial (HFC) network 10 may include a head end 12 that delivers content over a forward path to a node 14 using an optical transmission line 16. The node 14 may in turn deliver content to a plurality of subscribers 20 over a coaxial network 18. Subscriber's homes are typically connected to the node 14 using trunk cables 17 and feeder cable or “taps” 19. The HFC network 10 may likewise transmit signals over a return path from each of the subscribers 20 to the node 14 through the coaxial network 18, which in turn transmits the return path signal to the head end 12 through an optical transmission line 22.

The head end 12 may preferably modulate a plurality of QAM channels using one or more EdgeQAM units 24. The QAM modulation of these channel will be described later in this disclosure. The respective channels may be combined by an RF combining network 26 that multiplexes the signals and uses the multiplexed signal to modulate an optical transmitter 28 (e.g., a laser) that delivers the optical signal to transmission line 16. The head end 12 may also include an optical receiver 30 that receives return path signals from the optical transmission line 22 and delivers the return path signals to a Cable Modem Termination System (CMTS) 32, which instructs each of the cable modems when to transmit return path signals, such as Internet protocol (IP) based signals, and which frequency bands to use for return path transmissions. The CMTS 32 demodulates the return path signals, translates them into (IP) packets, and redirects them to a central switch (not shown) that transmits the IP packets to an IP router for transmission across the Internet. It should be understood by those skilled in the art that this configuration may be modified in any number of manners. For example, one or more of the EQAM units may be analog modulated or digitally modulated, or may be directly modulated in a Converged Cable Access Platform (CCAP). Similarly, the head end may include an A/D converter between the RF combining network 26 and the optical transmitter 28 so as to modulate the optical signal to the node using a digital rather than an analog signal.

The node 14 may include an optical receiver 34 to receive a forward path signal from the head end 12 over the optical transmission line 16, along with an optical transmitter 36 to send the return path signals to the head end 12 over the optical transmission line 22. The optical receiver 34 is preferably capable of demultiplexing a received optical signal and using the demultiplexed signals to modulate respective RF signals sent to subscribers 20 through a network of amplifier units 38 and diplexers 40. As noted previously, the respective RF signals communicated between the node 14 and the subscribers 20 include both forward path and reverse path transmissions, both typically carried over a common coaxial cable.

As can be appreciated from FIG. 1, the node 14 must be capable of separately processing the forward and return path signals that are propagated on the same coaxial cable. In FIG. 1 for example, CATV amplifiers such as the amplifier units 38 amplify the forward path signal and the return path signal simultaneously. Thus, the amplifier units 38 may typically be operatively connected to a minimum of two diplex filters—a first diplex filter that separates the return path from the forward path, after which these RF signals are separately amplified, and then a second diplex filter (e.g. diplexers 40) that recombines the separated signals onto a common coaxial cable sent to a subscriber 20 or to a head end.

Those of ordinary skill in the art will appreciate that other HFC architectures than that shown in FIG. 1 may also be used to communicate communications signals. For example, distributed access architectures may be employed that move much of the functionality shown in the head end (e.g., the EQAM modules 24 and/or portions of the CMTS functionality) into the nodes 14. Such distributed access architectures include R-PHY and R-MACPHY architectures. Those of ordinary skill in the art will also appreciate that, although a HFC network is used to illustrate the benefits of the systems and methods described in the present specification, other types of communications networks that communicate data using RF spectrum may also benefit from the disclosed systems and methods

As previously noted, and regardless of the communications system or particular architecture involved, management of a RF data network requires periodic measurement of state variables that represent system health or status. Such measurements in an HFC network can include, for example, full-band spectrum (FBS) capture data, pre-equalization coefficients, impulse noise measurements, histograms, Modulation Error Ratios (MER), etc.

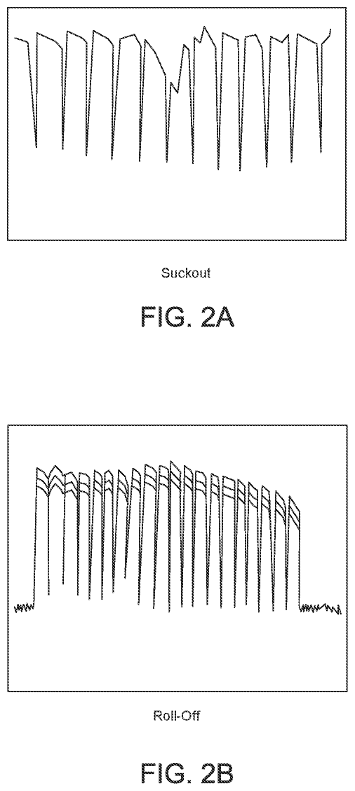

Also as already noted, it is desirable to detect and mitigate RF network impairments to prevent degradation of Quality-of-Service (QoS) to customers. These impairments may have myriad manifestations depending on the application or communications network at issue, but typical RF impairments that occur in the cable coaxial networks are suck-out, tilt, roll-off, etc. FIG. 2A shows an exemplary instance of a suck-out impairment, where signal strength suddenly dips and recovers over a portion of the spectrum. Suck-out is typically caused by amplifier imperfections or impedance mismatches in transmission lines that cause reflections. FIG. 2B illustrates an exemplary instance of a roll-off abnormality where signal strength gradually falls off in a nonlinear fashion towards one end of the spectrum. Roll-off may be caused by amplifiers, where the gain typically falls off at higher frequencies, or by filters intended to operate within a limited spectrum, beyond which the filter effects rapidly fade. Another common abnormality is RF tilt, which is caused by the fact that higher frequencies of a signal are attenuated more severely as that signal propagates through a medium

Regardless of the particular type of abnormality, human identification of the abnormalities by visual review of the RF spectral signal is time consuming and inefficient. The present application discloses techniques for the automated detection of RF impairments or abnormalities in spectral capture measurement such as PNM data. In one embodiment, the automated detection algorithm may be a Signal Processing (SP) algorithm that searches for predefined patterns typically associated with RF abnormalities—such as the patterns shown in FIGS. 2A and 2B, for example. In another embodiment, the automated detection algorithm may be a Machine Learning (ML) algorithm that processes a large training data set to identify features or characteristics of RF impairments, and subsequently uses those features (characteristics) to identify impairments in actual (non-training) data sets.

In either the SP or ML approach, it is beneficial to initially identify any part of the RF spectrum that is intentionally left un-used. For example, the downstream (DS) spectrum typically comprises frequencies between 54-860 MHz. Operators subdivide this DS spectrum for various services such as the high-speed data and video services. Within the spectrum used for high-speed service, single-carrier QAM channels and OFDM channels are placed in different frequency locations, where the video and SC-QAM channels are 6-Mhz wide, while the OFDM channels may be wider. Operators may choose to leave unused spectrum for various reasons—reserving bandwidth for future expansion of specific services, reserving bandwidth to avoid interfering with local FM/LTE or other regulated frequencies, or excessive bandwidth availability for the set of services currently offered. Moreover, the portion of the spectrum that is un-used can vary widely in different service groups depending on the type and tiers of residential and business services offered in those service groups

Because each of the SP or ML approaches require detection of abnormalities by identifying variations or patterns in the RF spectrum capture; not initially detecting these unused spectral frequencies can significantly degrade the efficacy of the impairment detection algorithms because (1) the transition between used and unused portions of the spectrum may be incorrectly identified by these algorithms as representing an abnormality, and (2) in the unused spectral frequencies since there is no transmitted power, hence the measurements captured with FBS capture are from random noise in the plant that may also be improperly identified as an abnormality. Thus, these unused portions should preferably not be analysed for potential impairments.

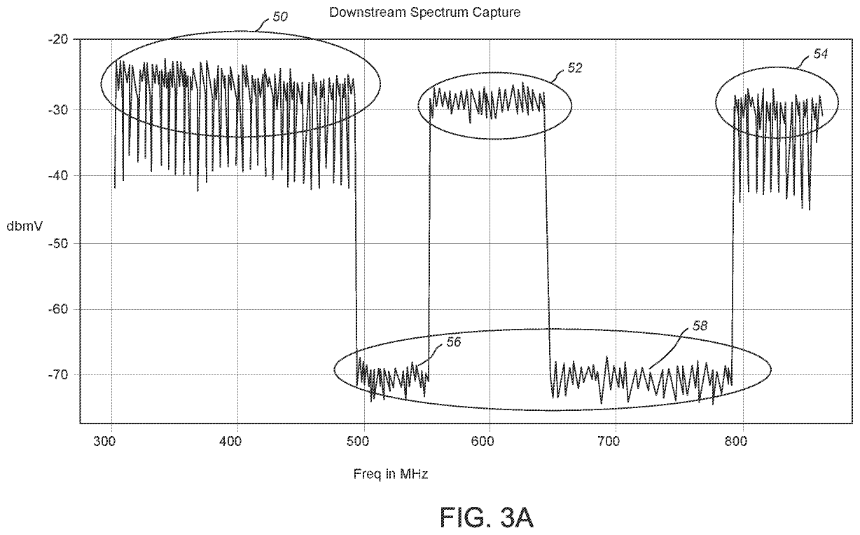

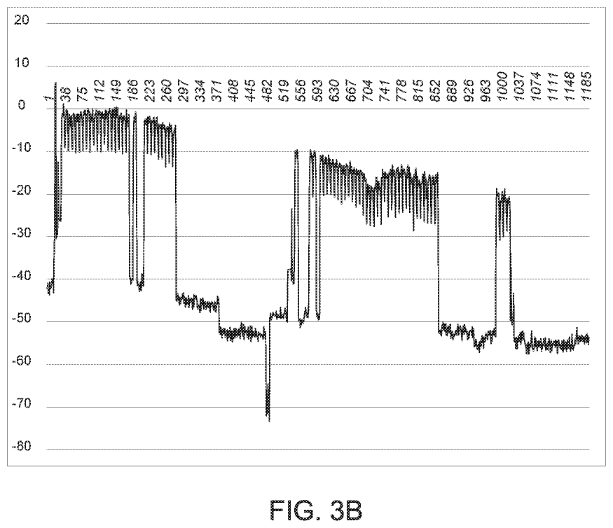

FIG. 3A shows an example of DS spectrum capture containing SC-QAM channels and OFDM channels along with portions of DS spectrum that are unused. In this figure, a first band 50 of spectrum from approximately 300-490 MHz is used to propagate SC-QAM channels, a second band 52 of spectrum from approximately 540-640 MHz is used to propagate OFDM channels, and a third band 54 of spectrum beginning from approximately 790 MHz is used to propagate more SC-QAM video channels. The band 56 between 490-540 MHz, and the band 58 between 640 MHz and 790 MHz are unused. FIG. 3B also shows another example of downstream spectrum capture containing un-used spectrum areas.

Preferred systems and methods disclosed in the present application may provide for efficient identification of RF impairments in RF spectrum used in data communications networks by first identifying unused portions of RF spectrum, infilling the unused spectrum in PNM data, and then subsequently using an automated detection algorithm for RF impairments. One method for detecting unused portions of spectrum is to receive information from a network operator identifying the unused spectrum, since network operators have foreknowledge of which frequency bands are used to communicate data and which are not, so that for example, cable modems may be instructed to tune to predetermined frequencies to receive particular channels of content.

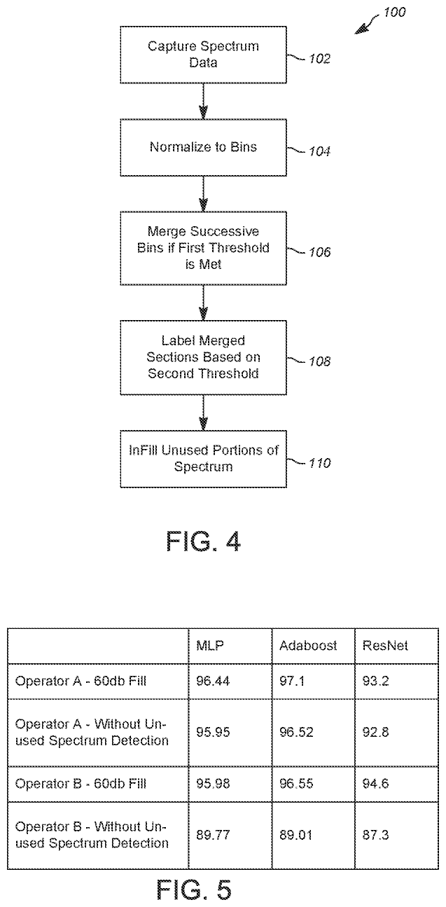

In other preferred embodiments, the automated RF impairment detection algorithm may be configured to automatically detect unused portions of spectrum. FIG. 4, for example, shows a preferred method 100 of automatically identifying unused portions of spectrum and subsequently infilling those unused portions of spectrum. In step 102, full band spectrum (FBS) data is captured. The FBS data can be captured at any one of a number of different frequency resolutions. For example, typical PNM measurements allow the power spectral density to be captured within different frequency bins such as 10, 25, 50 or 100 KHz, or even larger.

In step 104, the measurements captured in step 102 may be normalized to a larger frequency bin. For example, in the delivery of content and services in an HFC network, SC-QAM channels and OFDM channels use integral multiple of MHz frequency widths. Therefore, step 104 may normalize the power spectrum capture to 1 MHz bins, e.g., 300-301, 301-302 MHz, and so forth. In some embodiments. normalizing the spectrum values may involve converting the power spectrum values in dB scale to linear scale, adding the converted values, then converting the sum back to the dB scale after normalizing for the new frequency width of 1 MHz.

Those of ordinary skill in the art will appreciate that other values besides 1 MHz may be used in the normalization step 104. Preferably, however, the captured measurements of step 102 are normalized over a frequency range selected to evenly divide the full band of spectrum captured. For example, in an HFC network where channels are assigned to frequency ranges of 6 MHz, normalization may preferably occur over ranges of 1 Mhz, 2 MHz, and 3 MHz, but preferably not 4 MHz. If another communications network transmits signals in frequency bands of 25 MHz, then normalization may preferably occur over ranges of 1 MHz and 5 MHz, but preferably not 3 MHz or 10 MHz, and so forth.

In step 106, successive 1 MHz sections are merged together if they have power spectrum values that are within each other by a predefined first threshold. Stated differently, the first threshold is used to identify successive 1 MHz sections that are close to each other in spectral power, on the assumption that a transition from a used portion of spectrum to an unused portion of spectrum, and vice versa, involves a large change in spectral power. Then, in step 108, once the full spectral band has been processed through step 106, a second threshold is used to label successive merged sections as being used spectrum or unused spectrum. Specifically, unused spectrum will have very low spectral power as compared to used spectrum, so the second threshold can easily differentiate between unused spectrum and used spectrum.

At step 110, those sections identified as being unused are infilled. Different infill methods may be used, as desired. For example, a −60 db infill may be applied where the power spectrum values in the un-used areas are replaced with a constant −60 dB value. With this type of replacement, automated ML algorithms can learn to disregard the unused areas. Those of ordinary skill in the art will appreciate that the typical range of values for FSD capture is in the range −15 to +15 db, so the −60 db value rarely occurs in actual captures.

Alternatively, random values around a predetermined value may be used to infill unused sections of spectrum. In this method, instead of using a fixed value to fill-in, a random number generated around a fixed value, such as −60 dB, is used to infill the un-used spectrum values. Still another method may use and interpolation procedure where the value to the left and right of the unused area is used to interpolate the values in the unused area.

FIG. 5 shows the improvements in accuracy that result from infilling previously identified unused areas. The results shown in the table of FIG. 5. are from real-life spectrum data captured from two different operators and show an improvement in the accuracy of identification of RF impairments across the entire spectrum when the 60 dB fill is used. The degree of improvement is a function of the amount of unused spectrum in the FBS capture. As can be seen for certain operators (Operator B), there is a large gain in accuracy of detecting impairments when the un-used spectrum detection and infill is incorporated.

As indicated previously, over the past decade, CableLabs DOCSIS standards have introduced a variety of Proactive Network Maintenance (PNM) tests for the collection of operational data from various network elements such as cable modems and CMTSs. The operational data available in the network can be extremely large when taken at time intervals sufficient to allow proactive network management. Historically, the sort of data available in the cable network requires one skilled in the domain of radio frequency engineering to interpret the spectral data available from the system. Visually discerning the quality of an RF spectral signal is time consuming and fraught with nuance such that human review of this data is done in a reactive manner where issues are already known, as opposed to a proactive manner to determine where issues are arising that may not yet be causing major impacts on network performance and quality of service.

However, this data has not been sufficiently used to automate the detection of network impairments and to take remedial measures to alleviate network issues that can result in deterioration of the quality-of-service experience by the customers. Accordingly, as also already noted, some embodiments of the present disclosure may use machine learning algorithms to automatically identify RF impairments. This is not a trivial task. Application of machine learning techniques upon spectral samples has specific challenges when applied for classification. For supervisory based learning systems, training data must be available to train the algorithm as to what anomalous spectral data may look like. But for spectral based data there is unfortunately no systematic method for obtaining labeled data. Assuming that enough spectral samples are available with associated labels, not all systems include spectral energy across an the entire Full-Band System (FBS) capture. A full-band system from center frequencies 93 MHz to 993 MHz contains 151 6-MHz channels. In some cases, only a fraction of the 151 channels are configured for services and include transmitted spectral energy. With only a small number of service channels, issues such as RF Tilt or spectral ripple may be difficult to observe due to the large gaps between regions with transmitted channel energy. These gaps appear as noise in the full-band spectrum.

Another issue is that consumer premise equipment (CPE) necessary to capture the FBS data is not always available. CPE may be occasionally powered off, either by the customer or due to loss of power services. For downstream data, the CPE is necessary to capture the received data spectrum.

Moreover, when using a supervised algorithm, labeling of data can be difficult and costly. For RF spectrum, labeling of data may necessitate subject matter experts manually and meticulously looking through samples and adding labels to those subjectively determined to be abnormal. Lack of precise boundary definitions can confuse machine learning algorithms and decrease the performance of the ML algorithms. Additionally, the high volume of data associated with a full-band spectrum requires large memory and storage capabilities.

Much of the prior work done for ML for spectrum analysis is based on the use case of spectrum sensing—i.e., identification of whether a spectral block is available for use. Other related work has looked at Time Series Classification using Deep Learning, and some work has been performed in the more specific cases for DOCSIS and OFDM. Some prior work discusses the sources of data available in a DOCSIS network useful for machine learning approaches and the application of Deep Learning for classification while still other prior work evaluates the use of convolutional neural networks (CNN) as a multi-label classifier with RxMER data in an OFDM channel.

This specification discloses various embodiments of Machine Learning algorithms to categorize downstream Full-Band Spectrum (FBS) capture data extracted from cable modems, and also discloses various pre-processing techniques to normalize the spectrum data and other challenges that are encountered in the processing pipeline. Preferred embodiments disclosed herein focus on downstream FBS data across the entire plant including SCQAM and OFDM spectrum. In some preferred embodiments, all RF impairments may be organized into a single group where the initial characterization of the group is based on a few simple RF evaluation metrics.

Different ML algorithms with various levels of complexity are disclosed and evaluated, which each identify and categorize the presence of spectrum impairments. The present specification discloses techniques for closed-loop identification of RF impairments, and also discloses the results of experiments that used real-world field data collections. For these experiments, CPE were chosen randomly for the dataset, in which more than 15,000 random FBS records were retrieved for evaluation. This size data set requires server quality hardware; for example, this data set was unable to process on a laptop computer with 8 GB of memory under the current process implementation.

Data was collected from two CMTSs using the PNM Downstream Spectrum Capture using Simple Network Management Protocol (SNMP) to set up and trigger each data sample. In some preferred embodiments, for each CMTS, data may captured from each available cable modem across all service groups at the same time of day, once or twice per day and placed into a database, such as a Cassandra database. The full spectrum captures preferably include FBS data across a wide range of frequencies with a high sampling rate. For example, in the experiments reference above, FBS data was captured from 93-993 MHz center-frequency channels sampled at 256 bins per channel representing 151 6-MHz data, video, or unused channels.

FIG. 1 shows an exemplary processing flow 150 that produces output from a machine learning algorithm. Specifically, data may be collected at step 152 in a database as described above. Preferably, the database may be queried by specific CMTS source, date and time of capture, interface index, or specific cable modem MAC address. In the experiments described in this specification, the database includes over two million capture samples. Once the data has been ingested into the database, a dataset may be extracted at step 154, after which the data may be auto-labeled and preferably spectrally filled at step 156. The labeling and optional infilling may in some preferred embodiments be done in accordance with the foregoing description of FIGS. 3A, 3B, and 4. Features may be extracted from the labeled/infilled data sampled at step 158 and at step 160 the samples/features are provided to the machine learning algorithm.

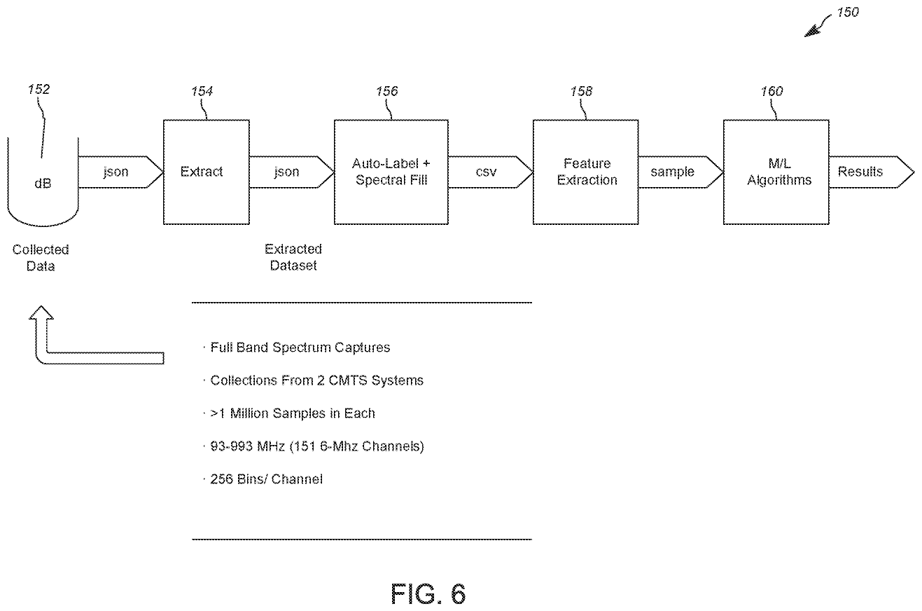

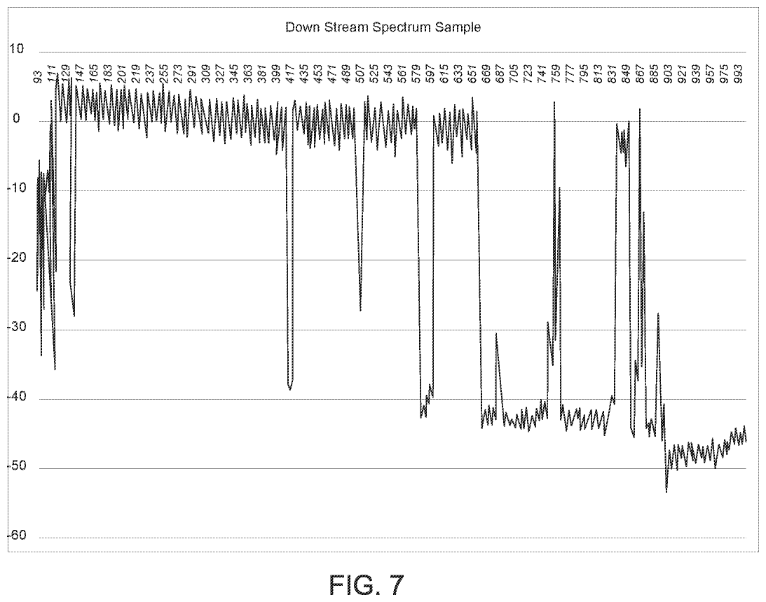

Referring to step 154 of FIG. 6, data queries may be generated by an extraction program for datasets of interest. The data may be placed in a comma-separated value format. Data extraction queries may be based on day and time of samples, device MAC-address, service group, or any combination of the foregoing. In the experiments described in this specification, all data samples were pulled randomly from available cable modems among all service groups and all available dates and collection times for each CMTS system. Extracted data for each CMTS were held in separate files to evaluate differences in results pertaining to different unique system characteristics of each system.

Referring to step 156 of FIG. 6, for the purposes of evaluation of machine learning algorithms, an auto labeling component is used. This auto-labeling component uses specified RF metric evaluation to determine the relative quality of an individual spectral sample. The auto-labeler preferably labels each full-band spectral sample as either good or not good (‘impaired’). The full-band capture may preferably be evaluated using the following RF-based metrics: (a) power in one or more channels does not fall within the DOCSIS specification range for received power (−15 dBmv to +15 dBmv); (b) the power level difference from a channel to either adjacent channel is greater than 3.5 dB; (c) a max3 calculation defined as the change in power of any points within a consecutive 3 MHz channel spectrum is greater than 3.5 dB; and (d) a max6 calculation defined as the change in power of any points within a consecutive 6 MHz channel spectrum is greater than 3.1 dB. Those of ordinary skill in the art will appreciate that other metrics may be used in addition to, or in substitution of, the ones listed.

Samples that failed one or more of the above tests (metrics) may be flagged as ‘impaired’ for the purposes of a machine-learning training set. Spectrum samples that passed all tests may be labeled as ‘good.’ Those of ordinary skill in the art will appreciate that samples labeled ‘impaired’ for this purpose do not necessarily mean customer services are impaired. A better description might be that the margin between current operating condition and eventual service degradation is less than ideal.

The FBS captures provide data for all channels between 93 MHz and 993 MHz inclusive. Not all channels in this wide range include active video or data services and thus have no transmitted energy in the 6 MHz channel. These channels are labeled as ‘unused’. Early tests indicated that unused channels could possibly impact the overall performance of the machine learning algorithms in categorizing impairments. Unused spectrum may also contain ingress from unwanted sources or include other noise sources from the cable plant.

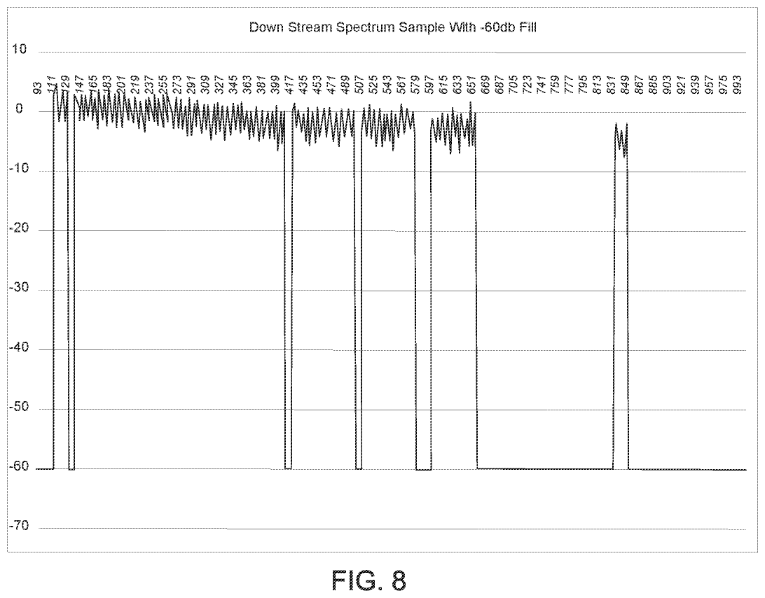

To assess the impact of data associated with unused channels, the auto-labeler may incorporate a channel sensing algorithm to generate a list of active channels across the spectrum. The channel sensing algorithm determines 6 MHz channel energy and other attributes to compare with thresholds to determine presence or absence of a channel. The output of the auto-labeler includes a list of frequencies for which active channels are present. The complement of this list is therefore the list of unused 6 MHz channels in this spectrum. This complement list may be used to evaluate different techniques to aid the final spectral classification. The options evaluated may include: (a) do nothing with the channel gaps and process ‘as is’ or (b) fill the channel slots that have no transmitted energy with a fixed value of −60 dBmV. In this embodiment, a fixed −60 dB fill was selected with the notion that the characteristics of a simple ‘line’ fill may ease the identification burden on the algorithm from unused spectral capture of a real received RF signal which includes random noise power. However, other values may be used in other embodiments. FIGS. 7 and 8 show a typical RF FBS capture, and with a −60 dBmV fill, respectively.

The datasets may preferably be taken from field data on operational systems. The number of samples that were labeled ‘impaired’ were a small subset of the overall number of samples included in the set. Once the labeling is completed, the data sets may be trimmed by removing some of the samples labeled ‘good’ to improve the balance between the number of ‘good’ labeled samples and ‘impaired’ labeled samples, hence the final sets would have a slight bias toward ‘good’ samples.

Referring to step 158 of FIG. 6, available data sets may be fed into a feature extraction program. The objective of the feature extraction algorithms is to reduce the total number of features associated with a spectral sample to something smaller and more explanatory to the output labels. In absence of the feature extraction algorithm the entire dataset is effectively a set of 38 k individual features, each spectral bin treated as a data feature. Using a feature extraction algorithm, the total number of features per sample may be reduced by orders of magnitude to allow for faster and lower cost processing of the data. As described later in the specification, the systems and methods disclosed in the present application were evaluated using four different machine learning algorithms. The reduced size feature sets were used in three of these four algorithms. while one of the algorithms uses the FBS spectrum directly.

TSFresh is a generic feature extraction library utilized for this purpose based on M. Christ, A. W. Kempa-Liehr and M. Feindt, “Distributed and Parallel Time Series Feature Extraction for Industrial Big Data Applications” (2017). No specific domain knowledge is leveraged for feature extraction. TSFresh is an opensource python package for feature extraction of time-series based data, but applicable to any uniformly sampled data, in this case spectral samples. TSFresh includes a basic set of 788 single value features extracted from each of the data samples where data sample refers to an individual FSB capture.

Some examples of the features calculated by TSFresh include Absolute Energy, where all values in the sample are squared and summed to a single value. A second example feature is Max value where only the maximum value of the entire sample is retained. Other features include autocorrelation where the autocorrelations of each sample are taken with all possible lags (for example delay by 1, 2, 3, . . . up to n−1 bins) and the results are summed together. Upon the calculation of the TSFresh features, the initial spectral samples are no longer required, the original labels are retained with the newly computed TSFresh feature set.

Principal component analysis (PCA) is another technique that may be further applied to the extracted features to reduce the feature set to a smaller set. PCA is a linear algebra technique that accomplishes dimensional reduction using linear transformations of features to determine the optimal linear combinations of features and their contribution to the overall explanation of the sample output labels, discarding features that have insignificant value. The machine learning algorithms tested in this specification were evaluated using the extracted feature set from TSFresh using PCA to further reduce the feature set, using a PCA threshold of 99%.

Referring to step 160 of FIG. 6, and as noted earlier, this specification discloses an evaluation of a number of machine learning algorithms in conjunction with the disclosed embodiments. The evaluated machine-learning algorithms include:

Adaboost—Adaboost is a decision-tree based algorithm that makes use of many simple decision tree classifiers. Adaboost utilizes a base classifier, in this case a decision tree classifier. The Adaboost algorithm builds a final classifier using weighted sample data over a series of training passes. The best decision trees in each pass are added to a final weighted decision tree classifier set.

Logistic Regression (LR)—In logistic regression, a logit function is used to create a best-fit decision boundary between samples labeled as good or bad resulting in a linear decision boundary. The LR algorithm is optimized using the training data to minimize the error of the fitted data. Samples are compared against the constructed decision boundary and labeled accordingly.

Multi-level Perceptron (MLP)—A MLP is the simplest form of neural network that may be used for classification problems. A MLP produces a non-linear decision boundary using a network of simple nodes.

ResNet—ResNet is a convolutional neural network architecture developed for deep-learning. The ResNet architecture solves issues associated with vanishing gradients and accuracy degradation with deep learning architectures. ResNet is the only algorithm that uses FBS samples directly without feature extraction and PCA reduction

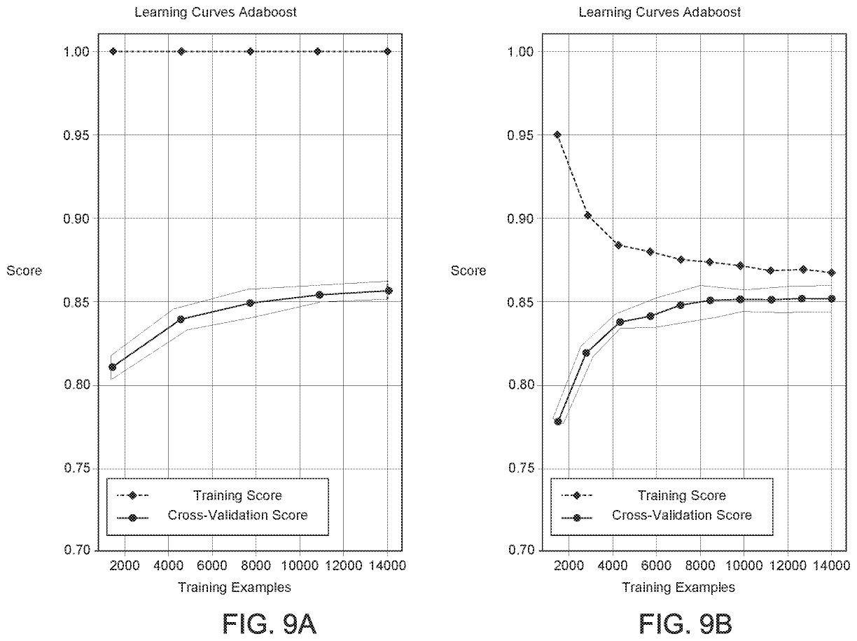

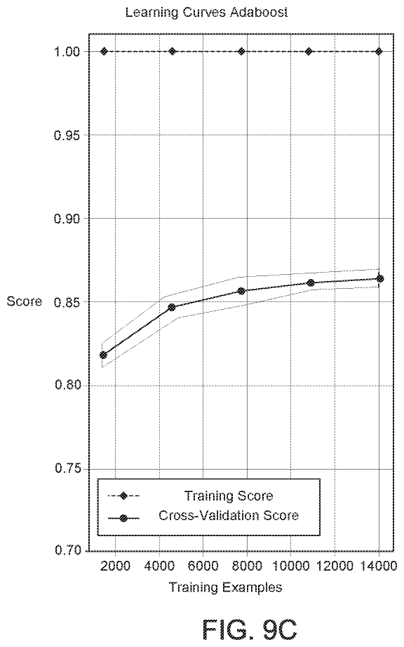

Learning curves can be useful to provide guidance on whether an algorithm is being over trained (i.e., over-fitting) or is not being trained with enough data. To perform a learning curve analysis, a large data set was extracted using data from the network connected to one of the two CMTSs (System B as described below) that provided data for the experiments herein described. The algorithms were trained using varying amounts of training data from 2 k samples to 12 k samples. For each level of training, test and training accuracy were recorded. Learning curves for MLP, LR, and AdaBoost algorithms are shown in FIG. 9. These learning curves indicate that training samples above 10-12 k provide little additional gain in the overall testing performance of the algorithms. The learning curves are useful to get a general idea on the training necessary for the algorithms. Note that the learning curves may be different for each of the different data sets—i.e., System A, System B (as described below) with and without −60 db fill. Learning curves may be generated using a particular set of hyper-parameters for each of the algorithms. Hyper-parameters are parameters that impact the algorithmic model configuration. Examples of hyper-parameters are the specific method for gradient search, a regularization parameter value, or the specific activation function of a neural network. Because hyper-parameter tuning was performed for each test, the actual hyper-parameters may change from those used in the learning curves. Nevertheless, the learning curves can provide some useful guidance on the data set size.

For each algorithm, the data set may be split into a training set and test set. The split between training and test sets may, for example be 75% and 25% respectively of the overall data set though those of ordinary skill in the art will appreciate that other ratios may be used. The training set and test set may each consist of the features extracted along with the auto-generated labels. The training set may be used to train the machine-learning algorithms while the test set is used once the algorithms are appropriately trained to evaluate the algorithm on similar but different data that it has been trained on. The training set is preferably normalized prior to training to prevent any features from dominating training due to scale.

For each algorithm, hyper-parameters may be tuned using both the training set and test sets prior to a final training and test evaluation. Once the test set is completed the algorithm performance may be calculated based on the predicted values of the test set results and the actual values as labeled by the auto-label process. Accuracy and confusion matrix results are recorded for each data set.

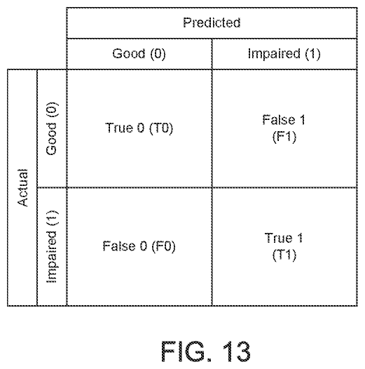

A typical confusion matrix is shown in FIG. 13. Samples for spectrum may be labeled 0 for “good” spectrum and labeled 1 for “impaired” spectrum. The confusion matrix is therefore given in FIG. 13 as “Good” samples (0) or “Impaired” samples (1). The confusion matrix of FIG. 13 shows values T0, T1, F0, and F1.

Accuracy is the total number of correct classifications over the entire set of tested samples, and may be defined as

Accuracy=(T0+T1)/(T0+F0+T1+F1).

Precision is useful to describe the relevancy of the ‘impaired’ samples resulting from the testing predictions, and may be defined as

Precision=T1/(T1+F1).

For example, if all samples classified as ‘impaired’ by the algorithm are actually labeled ‘impaired’ the Precision value would be 100%. If 25% of those classified as ‘impaired’ by the algorithm were ‘good’ samples mistakenly classified as ‘impaired’, the accuracy would be 75%.

Recall is useful to describe the completeness of the classified set as determined from the algorithm, and may be defined as

Recall=T1/(T1+F0).

If the results classified as ‘impaired’ included every ‘impaired’ sample in the actual data set, the Recall would be 100%. If 25% of the actual ‘impaired’ samples were classified as ‘good’ they would not appear in the ‘impaired’ list. The resulting Recall in this case would be 75%. Note that 100% Precision does not imply 100% Recall or vice-versa.

The following tables provide the confusion matrix details for each of the trials. In these tables, the Precision and Recall numbers are provided in reference to ‘impaired’ classifications. The table values are prefixed by the algorithm, e.g., LRT0 is the True 0 value for the Logistic Regression, ABF0 is the False 0 for the AdaBoost algorithm, and MLPT1 is the True 1 value for the MLP algorithm

| System | Interp | PCA | Samples | LRT0 | LRF1 | LRF0 | LRT1 | LRPrec | LRRecall |
|---|---|---|---|---|---|---|---|---|---|
| A | None | 90 | 11226 | 1310 | 114 | 182 | 1201 | 91.3% | 86.8% |
| A | None | 99 | 11226 | 1308 | 116 | 161 | 1222 | 91.3% | 88.4% |
| B | None | 90 | 16296 | 1652 | 425 | 264 | 1733 | 80.3% | 86.8% |
| B | None | 99 | 16296 | 1734 | 343 | 295 | 1702 | 83.2% | 85.2% |
| A | 60 db | 90 | 11226 | 1216 | 208 | 204 | 1179 | 85.0% | 85.2% |
| A | 60 db | 99 | 11226 | 1287 | 137 | 155 | 1228 | 90.0% | 88.8% |
| B | 60 db | 90 | 16296 | 1705 | 371 | 379 | 1619 | 81.414 | 81.0% |
| B | 60 db | 99 | 16296 | 1766 | 310 | 298 | 1700 | 84.6% | 85.1% |
| System | Interp | PCA | Samples | ABT0 | ABF1 | ABF0 | ABT1 | ABPrec | ABBecall |
| A | None | 90 | 11226 | 1277 | 147 | 155 | 1228 | 89.3% | 88.8% |
| A | None | 99 | 11226 | 1274 | 150 | 175 | 1208 | 89.0% | 87.3% |
| S | None | 90 | 16296 | 1684 | 393 | 286 | 1711 | 81.3% | 85.7% |
| B | None | 99 | 16296 | 1691 | 386 | 298 | 1699 | 81.5% | 85.1% |
| A | 60 db | 90 | 11226 | 1282 | 142 | 196 | 1187 | 89.3% | 85.8% |
| A | 60 db | 99 | 11226 | 1297 | 127 | 165 | 1218 | 90.6% | 88.1% |
| B | 60 db | 90 | 16296 | 1775 | 301 | 284 | 1714 | 85.1% | 85.8% |
| B | 60 db | 99 | 16296 | 1814 | 262 | 244 | 1754 | 87.0% | 87.8% |
| System | Interp | PCA | Samples | MLPT0 | MLPF1 | MLPF0 | MLPT1 | MLPPrec | MLPRecall |
| A | None | 90 | 11226 | 1318 | 106 | 128 | 1255 | 92.2% | 90.7% |
| A | None | 99 | 11226 | 1326 | 98 | 114 | 1269 | 92.8% | 91.8% |
| B | None | 90 | 16296 | 1764 | 313 | 269 | 1728 | 84.7% | 86.5% |
| B | None | 99 | 16296 | 1802 | 275 | 260 | 1737 | 86.3% | 87.0% |
| A | 60 db | 90 | 11226 | 1297 | 127 | 157 | 1226 | 90.6% | 88.6% |
| A | 60 db | 99 | 11226 | 1330 | 94 | 163 | 1280 | 93.2% | 92.6% |
| B | 60 db | 90 | 16296 | 1821 | 255 | 231 | 1767 | 87.4% | 88.4% |
| B | 60 db | 99 | 16296 | 1841 | 235 | 229 | 1769 | 88.3% | 88.5% |

The data sets for this analysis have been extracted from two different networks in different geographical locations. Both data sets were taken randomly from each network. The characteristics of the data sets are provided in Table 1 below.

TABLE 1

| | | Unused | |
|---|---|---|---|
| | | Spectrum | |
| System | Samples | (%) | Bias (%) |
| A | 11226 | 24.65 | 51.283 |
| B | 16296 | 32.01 | 51.283 |

This table lists the number of samples, initial bias, and amount of unused spectrum based on the aggregate of all the samples in that set. The “Unused Spectrum” is an aggregate value calculated by counting the number of bins in each spectrum capture that have been filled during the spectral fill process divided by the total bins in each full spectrum capture, where each individual sample may have more or less unused spectrum than the overall aggregate percent. The “Bias” is calculated by summing the number of labels=‘1’ (‘impaired’) divided by the total number of samples in the set and subtracting from 1. A number greater than 50% reflects the situation that the Bias represents a slightly greater number of ‘good’ samples than ‘impaired’ samples in each set.

Each of the algorithms were run across data sets from two different systems to evaluate performance among the algorithms and differences among the data sets. Feature sets were created using Principal Component Analysis (PCA) with only features meeting a prescribed threshold of 99% used. For reference, the full TSFresh feature set consists of 788 different feature metrics.

For each algorithm, the ML classifier was trained using the training set. The specific approach to training differs depending on the ML algorithm. For example, with MLP, the entire training set is passed through the algorithm, called an epoch, after which a cost function is used to update the MLP weights using a statistical gradient descent search and learning rate. After many epochs, the MLP weights approach the optimal values for performance. Once training is complete, the test set is passed through the MLP. he specifics of training for each of the algorithms are different, the general concept of optimizing the performance using the training set and evaluating using the test set is the same. For each sample in the test set, an output prediction (‘good’ or ‘impaired’) is generated. The prediction is then compared with the actual label for that sample. Accuracy is defined as the total number of correct output predictions divided by the total number of samples in the test set

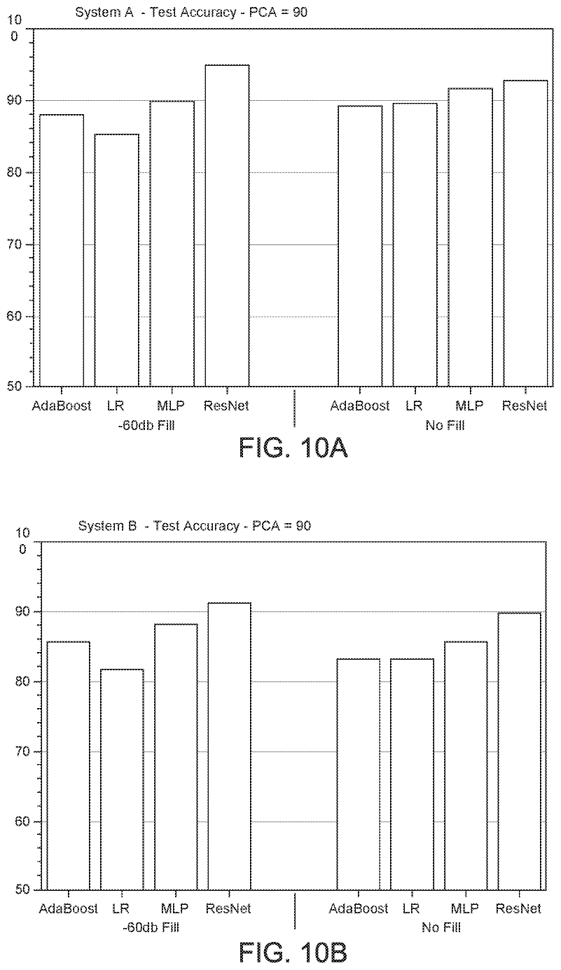

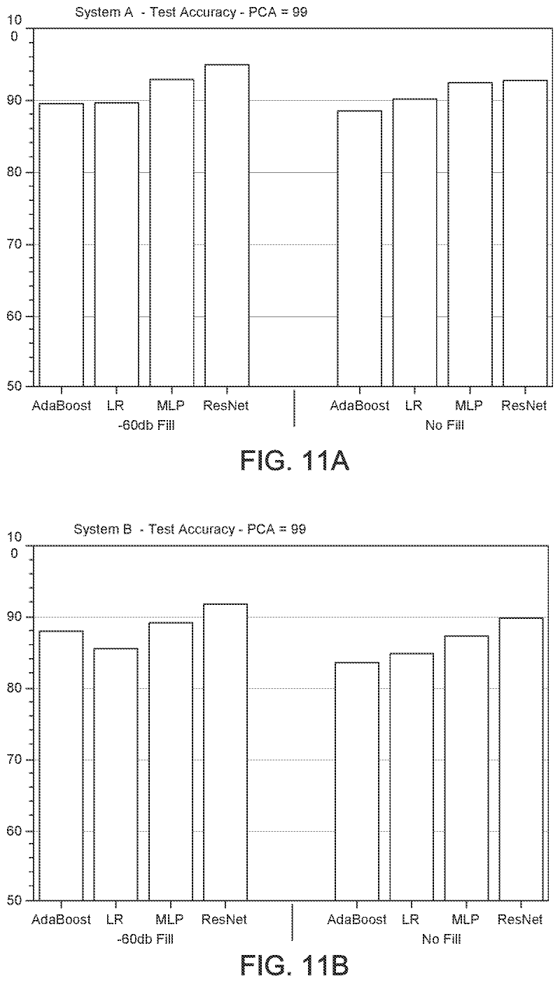

FIGS. 10A and 10B show the results using the 99% PCA feature set for systems A and B in graphical format respectively, while Table 2 and Table 3 below provide the results in tabular format. Table 2 and Table 3 include an additional column providing the difference in accuracy between the case of no fill and that of −60 dB fill. The number is referenced to the case of no-fill so that a positive number represents the case where a −60 dB fill improved the results. Table 4 shows the number of PCA extracted features for each dataset.

### System A

TABLE 2

| | NoFill | −60 db Fill | Diff |
|---|---|---|---|
| ADABOOST | 88.42 | 89.6 | 1.18 |
| LR | 90.13 | 89.6 | −0.53 |
| MLP | 92.45 | 92.98 | 0.53 |
| RESNET | 92.8 | 94.9 | 2.1 |

### System B

TABLE 3

| | NoFill | −60 db Fill | Diff |
|---|---|---|---|
| ADABOOST | 83.21 | 87.58 | 4.37 |
| LR | 84.34 | 85.08 | 0.74 |
| MLP | 86.87 | 88.61 | 1.74 |
| RESNET | 89.6 | 91.2 | 1.6 |

TABLE 4

| | | Extracted |
|---|---|---|
| System | Fill | Features |
| A | None | 251 |
| B | None | 258 |
| A | 60 db | 172 |
| B | 60 db | 152 |

In reviewing the results, it is apparent that all machine learning algorithms evaluated performed significantly better than simply categorizing all samples as ‘good’ which would provide about a 51% accuracy.

Second, the performance of System A and System B were not identical, System A generally tended to have better results than System B across all the ML algorithms. This observation could be related to the fact System A had fewer unused channels than System B.

At the individual algorithm level, ResNet tended to have better results than the other algorithms with MLP being a close second. These algorithms are based on neural network models capable of creating complex decision boundaries.

With the exception of LR, all the algorithms benefitted from the synthetic −60 db fill with Adaboost performance bumping by over 4% when using System B data. One possible explanation for LR is that LR generates a linear decision boundary. Given the feature set extracted, the actual decision boundary is likely not linear which may limit the general overall performance of LR. Additionally, the level of improvements from using the synthetic −60 dB fill were greater in System B. This may also be due to the fact that System B included a greater amount of unused spectrum than System A, making the synthetic fill more impactful across the samples in System B.

As indicated above, several machine learning algorithms were evaluated for their ability to categorize full band spectral data from DOCSIS systems as either impaired or not impaired. The machine learning algorithms evaluated are supervisory based algorithms where labeling for training and testing was provided using traditional RF signal processing approaches. Data sets were generated from field FBS captures from two different CMTSs with different configurations and network characteristics. The results of applying the machine learning algorithms to the data show that the use of machine learning algorithms provided significant gain in identifying impaired spectrum from non-impaired spectrum according to the labeling system used. In addition, using a spectral fill algorithm consisting of a simple constant value for unused spectrum improved the categorization accuracy by over 4% with the Adaboost algorithm and nearly 2% with the ResNet algorithm in one case. In general, neural network based algorithms tended to provide the best overall prediction accuracy. The system with the least unused spectrum exhibited the best performance while using the synthetic −60 dB fill provided a greater performance improvement for the system with the greater amount of unused spectrum.

This specification discloses the potential for using full band spectrum capture data for the identification of potential impairments in a DOCSIS plant. As with any machine learning exercise, many steps of data processing and cleansing are needed prior to actual training and testing of the algorithms. Moreover, feature extraction and training of models are both time and resource consuming processes. Fortunately, once a model is trained, using the model to classify actual samples is a much quicker process.

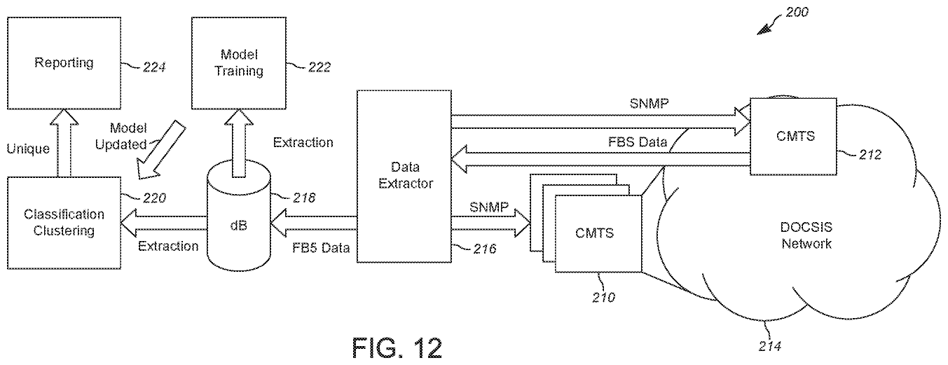

FIG. 12 shows the various processes necessary for an exemplary machine learning system as described herein, in a closed-loop configuration. Specifically, a system 200 may comprise one or more CMTSs 210 connected to a plurality of cable modems 212 via a network 214, e.g., a hybrid fiber coaxial (HFC) network, a PON network, etc. In some embodiments the network 214 may be a DOCSIS network. A data extractor 216 may preferably be operably connected to the one or more CMTSs 210 as well as the cable modems 214, and may operate to extract data in accordance with the foregoing embodiments i.e., as described with respect to step 154 of FIG. 6. The data extractor 216 may store received data (samples) in a database 218. These samples may be used by a machine learning system that includes a classification/clustering module 220, a model training module 222, and 1 reporting module 224.

Given a set of CMTSs managing a DOCSIS network, the Data Extractor 216 preferably periodically extracts the full-band spectrum data from the devices in the network. This can be a periodic task performing a PNM FSB test on each device once per day, preferably during early morning low utilization times, storing the results in a database. The classification and clustering system 220 preferably extracts data so as to classify each device as potentially problematic or as good. Additional clustering may also be employed using metadata from the captures such as service group identifiers. This would allow grouping devices with common network topology to help localize issues within the network distribution system. The classification system 220 also generates a report indicating devices that may be problematic and any indications of potential network trouble spots. The Model Training module 222 may periodically train the machine learning system, e.g., the classification/clustering module 220 using updated data collected and placed in the database. Updating models may be necessary in the event of network changes. As new training takes place, model evaluation should preferably be done from the prior model to the new model to obtain some indication on the dynamics governing the value of re-training the network

Referring again to FIG. 1, any of the foregoing systems, methods, and steps may be implemented in hardware 42 either integrated with, or connected to, head end 12 or any of its components, such as CMTS 32, a CCAP, or in distributed access architectures the hardware 42 may be implemented in a Remote Physical Device (RPD) or Remote MACPHY device (RMD) in a node, or may be connectable to such devices by any appropriate means, including an ethernet interface accessible over a LAN and/or a wide-area network, such as the Internet. The hardware 42 may preferably include a memory 46 to store collected PNR data and one or more processors 44 to process the data as previously described in this specification, and to configure the network based on the aggregated results.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein. In the event of inconsistent usages between this document and those documents so incorporated by reference, the usage in the incorporated reference(s) should be considered supplementary to that of this document; for irreconcilable inconsistencies, the usage in this document controls. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise,” or a derivative thereof, when used in a claim, is used in a nonexclusive sense that is not intended to exclude the presence of other elements or steps in a claimed structure or method.

1. A method comprising:
receiving measurements comprising RF power measured over a contiguous range of frequencies, where at least a first portion of the contiguous range is used to transmit signals and at least a second portion of the contiguous range is unused;
identifying respective boundaries of the at least a second portion of the contiguous range;
infilling the at least a second portion of the continuous range with RF power to provide modified measurements; and
automatically analyzing the modified measurements to identify at least one abnormality in a signal within the at least a first portion of the contiguous range.

2. The method of claim 1 where the step of automatically analyzing the modified measurements is performed by a Machine Learning (ML) algorithm.

3. The method of claim 1 where the step of automatically analyzing the modified measurements is performed by a Signal Processing (SP) algorithm.

4. The method of claim 1 capable of identifying at least one abnormality in the group consisting of suck-out abnormalities, roll-off abnormalities, and tilt abnormalities.

5. The method of claim 1 where step of identifying respective boundaries of the at least a second portion of the contiguous range comprises capturing power spectral density measurements over successive intervals of a first frequency width.

6. The method of claim 5 including the step of normalizing the captured spectral density measurements over a second frequency width larger than the first frequency width.

7. The method of claim 6 including the step of selectively merging adjacent ones of the normalized captured spectral density measurements based on a threshold.

8. The method of claim 1 where the step of identifying respective boundaries of the at least a second portion of the contiguous range comprises:
using a first threshold to segment the contiguous range of frequencies into segments of used portions and unused portions; and
using a second threshold to identify which of the alternating segments are used portions, and which of the segments are unused portions.

9. The method of claim 1 where the step of infilling the at least a second portion of the continuous range with RF power is based on a predetermined infill value.

10. The method of claim 9 where the predetermined infill value is selected to be of a magnitude of power less than what is used to transmit signals in the contiguous range of frequencies.

11. A system comprising:
a database operatively connected to at least one cable modem termination system (CMTS) and a plurality of cable modems exchanging information with the at least one CMTS over a network;
an extractor configured to periodically retrieve spectral samples from the cable modems and store the samples in the database; and
processor operatively connected to the database and configured to automatically use the samples to classify spectrum of each of the plurality of cable modems as being impaired or not impaired.

12. The system of claim 11 where the processor implements a machine learning algorithm.

13. The system of claim 12 where the processor uses the samples to train the machine learning algorithm.

14. The system of claim 13 where the processor separates the samples into a training set and a test set.

15. The system of claim 11 where the processor is configured to infill spectrum in at least one sample.

16. The system of claim 11 where the processor reduces a total number of features associated with a spectral sample.

17. The system of claim 16 where the processor uses Principal Component Analysis (PCA) to reduce the total number of features.

18. The system of claim 11 where the network is a DOCSIS network.

19. The system of claim 11 where the spectral samples are full band spectrum (FBS) samples.

20. The system of claim 11 where the FBS samples provide data for all channels between 93 MHz and 993 MHz inclusive.
